(19) United States
(12) Patent Application Publication
(10) Pub. No.: US 2012/0248898 A1
(43) Pub. Date: Oct. 4, 2012

(54) Moving Magnet Actuator Magnet Carrier

(76) Inventor: Richard Tucker Carlmark, Cumberland, RI (US)

(21) Appl. No.: 13/074,195

(22) Filed: Mar. 29, 2011

(51) Int. Cl. H02K 41/035

(52) U.S. Cl. 310/12.24

(57) ABSTRACT

A magnet carrier for a moving magnet actuator. The magnet carrier includes a single longitudinal beam extending in the direction of intended motion of magnet carrier and two pairs of transverse ribs, extending from opposite sides of the longitudinal beam. The longitudinal beam and the two pairs of transverse ribs are arranged to engage a pair of substantially planar magnet structures.

### BACKGROUND

This specification describes a moving magnet motor and more particularly a magnet carrier for a moving magnet linear actuator.

### SUMMARY

In one aspect of the specification, a magnet carrier for a moving magnet motor includes a single longitudinal beam extending in the direction of intended motion of magnet carrier; two pairs of transverse ribs, extending from opposite sides of the longitudinal beam. The longitudinal beam and the two pairs of transverse ribs are arranged to engage a pair of substantially planar magnet structures. The moving magnet motor is a linear actuator. The magnet carrier may include n>2 pairs of transverse ribs. The longitudinal beam and the n pairs for transverse ribs may be arranged to engage n−1 pairs of magnet structures. The magnet carrier may be configured to engage the magnet structures on three sides of the magnets structures and to not engage a fourth side of the magnet structure. The magnet carrier may be a unitary structure. The magnet carrier may be a multi-piece structure. A piece comprising the single longitudinal beam may include a ferrous material. The transverse ribs may be perpendicular to the longitudinal beam.

In another aspect of the specification, an armature for a moving magnet includes a magnet carrier. The magnet carrier includes a single longitudinal beam extending in the direction of intended motion of magnet carrier and transverse ribs, extending from the longitudinal beam. The longitudinal beam and the transverse ribs may be arranged to engage a substantially planar magnet on three sides of a quadrilaterally shaped magnet. The transverse ribs may extend from the longitudinal beam in opposite directions. The armature may be configured so that reactive force exerted on the magnet carrier is exerted in line with the single longitudinal beam. The armature magnet carrier may be a unitary structure. The magnet carrier may be a multi-piece structure. A piece comprising the single longitudinal beam may include a ferrous material. The magnet carrier may include n>2 pairs of transverse ribs. The longitudinal beam and the n pairs for transverse ribs may be arranged to engage n−1 pairs of magnet structures. The transverse ribs may be perpendicular to the longitudinal beam.

In another aspect of the specification, a linear actuator includes an armature for a moving magnet. The armature includes a magnet carrier. The magnet carrier includes a single longitudinal beam extending in the direction of intended motion of magnet carrier. The magnet carrier includes transverse ribs, extending from the longitudinal beam. The longitudinal beam and the transverse ribs are arranged to engage a substantially planar magnet structure. The armature is arranged so that reactive forces are applied to the armature in line with the single longitudinal beam.

Other features, objects, and advantages will become apparent from the following detailed description, when read in connection with the following drawing, in which:

### BRIEF DESCRIPTION OF THE SEVERAL VIEWS OF THE DRAWING

FIG. 1 is a simplified isometric view of a moving magnet linear actuator;

FIGS. 2A-2C are simplified top views and a simplified side view of a magnet carrier;

FIGS. 3A-3C are top views of a magnet carriers;

FIG. 4 is an isometric view of a magnet carrier;

FIG. 5 is a plot of force produce per input current vs. displacement; and

FIG. 6 is a top view of a magnet carrier and a top view of a magnet carrier with magnet structures.

### DETAILED DESCRIPTION

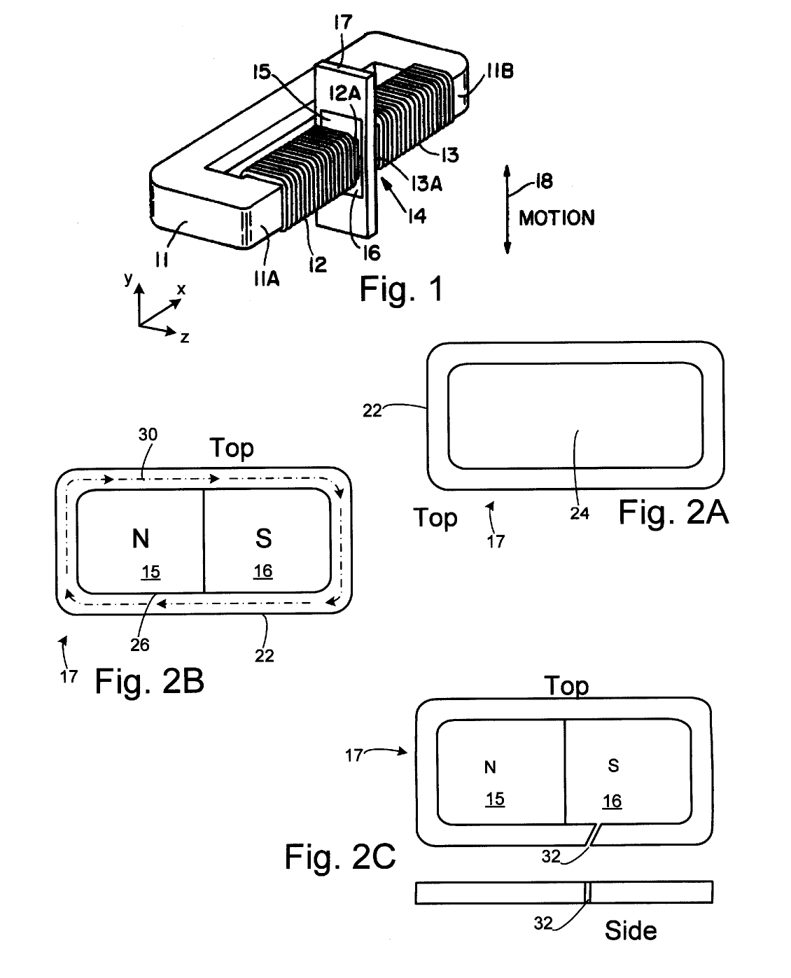

FIG. 1 shows a simplified isometric view of a moving magnet linear actuator. A first winding 12 and a second winding 13 are wound around legs 11A and 11B of a C-shaped core 11 of material of low magnetic reluctance, such as soft iron. Permanent magnets 15 and 16 seated in movable magnet carrier 17 are positioned in air gap 14 in the C-shaped core, preferably filling a much of the air gap as possible, without contacting the C-shaped core. Permanent magnets 15 and 16 have adjacent unlike poles, the boundary between the poles being located midway along the direction of relative motion 18, between opposed surfaces of core 11, when the current through windings 12 and 13 is substantially zero and with no other external force applied. The movable magnet carrier 17 and the permanent magnets 15 and 16 are components of the armature of the linear actuator; other components of the armature are not shown in this figure. The movable magnet carrier is supported by a suspension, not shown, that permits motion in the direction indicated by arrow 18 while opposing lateral (that is, X-direction according to the coordinate system of FIG. 1) “crashing” forces that urge the magnets toward the opposing faces of the C-shaped core. A suitable suspension is described in U.S. Pat. No. 6,405,599.

In operation, an alternating current signal, for example an audio signal, in the windings 12 and 13 interacts with the magnetic field of the permanent magnets 15 and 16, which causes motion of the armature in the direction indicated by arrow 18.

FIG. 2A shows a simplified view of the magnet carrier 17. A typical configuration for a magnet carrier is a frame 22 and window 24 configuration.

As shown in FIG. 2B, the frame 22 engages the magnet structure 26, which includes permanent magnets 15 and 16 of opposite polarity, on all four sides of the magnet structure 26. The magnet structure may be held in place mechanically by an adhesive, such as an epoxy, or by an interference fit with or without adhesive to supplement the interference fit. The magnet carrier may have structure (not shown) to couple the armature to surrounding structure so that the mechanical energy (motion and force) generated by operation of the linear actuator can be usefully employed.

Desirable characteristics for a material for a magnet carrier include low density, high elastic stiffness and strength, temperature stability, dimensional stability, low cost, and ease of forming (for example, extruding, machining and the like). Thermal conductivity is also desirable for thermal dissipation, particularly if the magnet includes an alloy including a rare earth material such as neodymium. Permanent magnet alloys containing rare earth metals lose magnetization at high temperatures. Metals are a class of material with these characteristics in quantities suitable for a magnet carrier in a linear actuator, with aluminum representing a good choice. Unfortunately, aluminum is also highly electrically conductive. The high conductivity combined with the window structure provides a closed electrical path, indicated by arrows such as arrow 30. The closed electrical path provides a path for the generation of eddy currents when an alternating magnetic field is generated by the coils of the actuator. The eddy currents result in ohmic heating which may result in loss of efficiency of the actuator, thermal damage to the actuator and to nearby components, and, as mentioned above, may cause rare earth magnets to demagnetize.

Other metal materials that have more resistivity, such as titanium, are expensive and may be difficult to form. Electrically non-conductive materials, such as polymers may not be dimensionally stable with time and temperature and may have undesirable thermally insulating properties.

One way of eliminating the closed electrical path is to place a small cut or break 32 in the magnet carrier frame, as shown in FIG. 2C. For purpose of illustration, the small cut or break 32 is shown greatly exaggerated. In an actual implementation, the cut may be as narrow as 0.2 mm. The cut or break may be filled with a non-conductive material such as a structural adhesive, for example epoxy. While the small cut or break eliminates the closed electrical path, it also compromises the structural integrity of the magnet carrier frame.

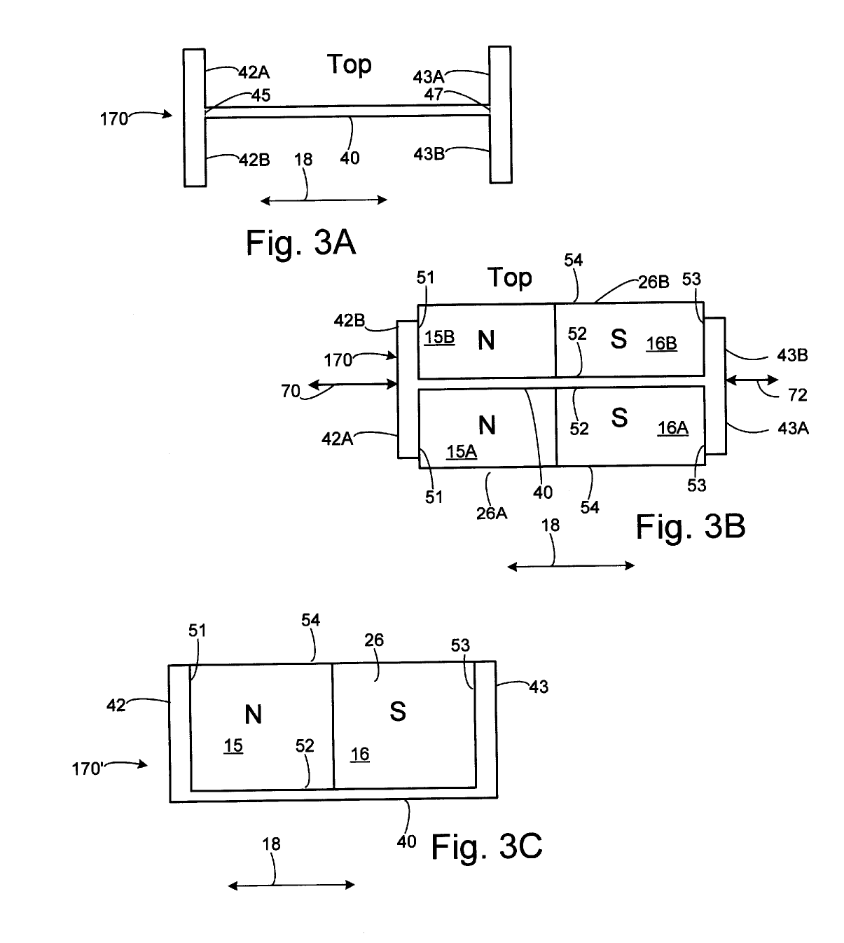

FIGS. 3A and 3B show a magnet carrier configuration that does not have a closed electrical path, but has high structural integrity. FIG. 3A shows the magnet carrier 170 without magnets 15A, 15B, 16A, and 16B in place, and FIG. 3B shows the magnet carrier 170 with magnets 15A, 15B, 16A, and 16B in place. The magnet carrier 170 has a single longitudinal beam 40 extending in the intended direction of motion of the armature indicated by arrow 18. Transverse ribs 42A and 42B extend from opposite sides of the single longitudinal beam in opposite directions, which may be perpendicular to the beam. Transverse ribs 42A and 42B may form a single line. Likewise, transverse ribs 43A and 43B extend from opposite sides of the single longitudinal beam in opposite directions, which may be perpendicular to the beam. Transverse ribs 43A and 43B may form a single line. Transverse ribs 42A and 42B and 43A and 43B lie in the same plane, and engage a pair of magnet structures 26A (including magnets 15A and 16A) and 26B (including magnets 15B and 16B) on three edges, 51, 52, and 53 of the magnetic structures 26A and 26B. The fourth edge 54 may be unconstrained. The magnet carrier 170 may be a unitary structure as shown, or may be non-unitary. For example, a three piece implementation could include three pieces, divided at dashed lines 45 and 47. One piece could include transverse ribs 42A and 42B; a second piece could include transverse ribs 43A and 43B; and a third piece could include the longitudinal beam 40. The third piece including the longitudinal beam could be made of a ferrous material to permit more magnetic material to be positioned in the air gap.

The magnet carrier may be coupled to other components of the motor so that the reactive force is applied in the direction indicated by arrows 70 and 72, which is in line with the longitudinal beam.

FIG. 3C shows another implementation 170′ of the magnet carrier of FIGS. 3A and 3B. In the implementation of FIG. 3C, the transverse ribs extend from longitudinal beam 40 on only one direction, and there is only one magnet structure 26 which includes two magnets 15 and 16. Other reference numbers refer to like numbered elements in FIGS. 3A and 3B. The implementation of FIG. 3A requires only one magnet structure 26, and can be implemented so that little or no non-magnetic structure is in the air gap, but has mechanical disadvantages compared to the implementation of FIGS. 3A and 3B.

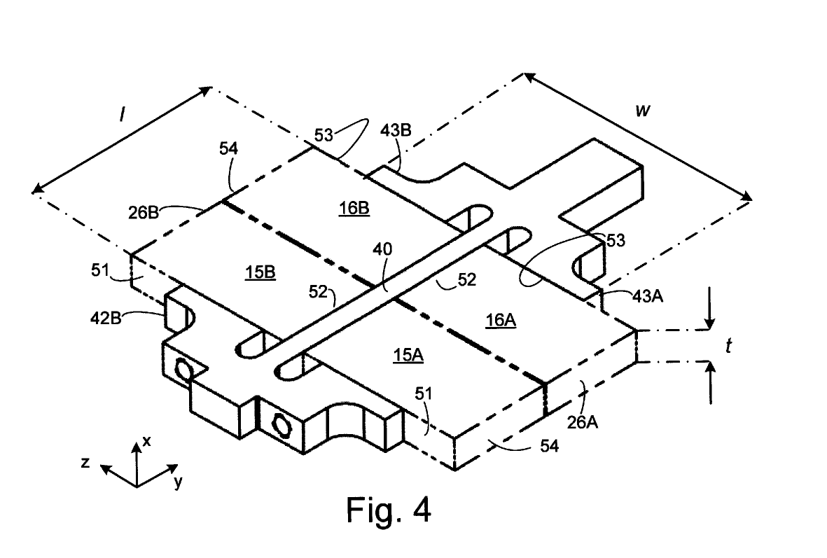

FIG. 4 shows an actual implementation of a magnet carrier according to FIGS. 3A and 3B. Reference numbers in FIG. 4 refer to corresponding elements with like reference numbers in FIGS. 3A and 3B. In the implementation of FIG. 4, the magnet carrier is made of aluminum, with a thickness t of 4.5 mm. The transverse ribs 43A and 43B have a width w of 36 mm. The magnet carrier is designed to accommodate magnet structures 26A and 26B of thickness 4.5 mm (in this example the same as the thickness, but in other examples, could be smaller), and a width w of 50 mm. In this implementation, the magnet is formed of a neodymium-iron-boron alloy.

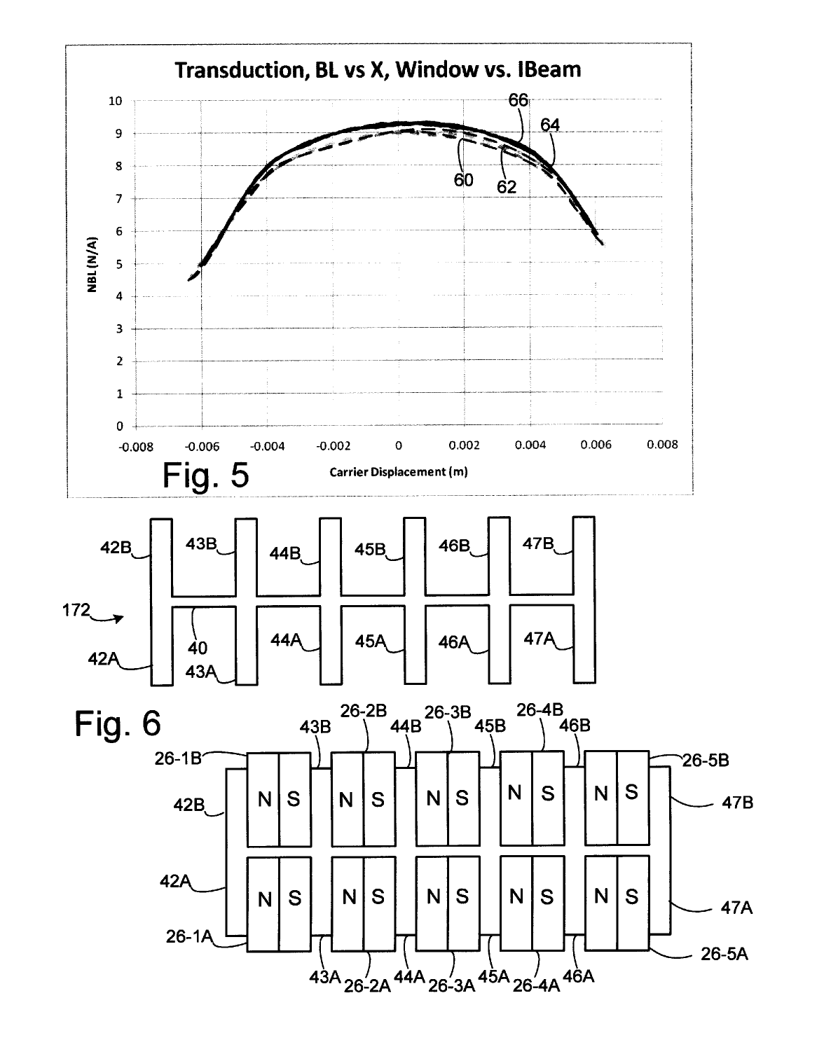

The magnet carrier configuration of FIGS. 3A, 3B, and 4 is advantageous over the magnet carrier configuration of FIG. 2. Magnet carriers according to FIGS. 3A and 3B can be inexpensively formed by forming an extrusion in the X-direction, and separating individual magnet carriers, for example by sawing in the Y-Z plane. There is no need to form the window of the configuration of FIG. 2, for example, by cutting. Since the magnet structure is not constrained in the Z-direction, less precision is required in the Z-dimension. Mismatch of thermal expansion/contraction between the magnet and the magnet carrier is detrimental only in the Y-direction, but not in the X-direction or the Z-direction. In a magnet carrier configuration according to FIGS. 3A, 3B, and 4, the non-magnetic beam 40 lies in the air gap of the C-shaped core 11. Non-magnetic material in the air gap may negatively affect transduction because less magnetic material is in the air gap. However, as shown in FIG. 5, the transduction coefficient (that is, the force produced per input current) of a linear actuator using a magnet carrier according to FIGS. 3 and 4 (represented by lines 60 and 62) is only about 2-3% less than a linear actuator using a conventional magnet carrier as in FIGS. 2A-2C (represented by lines 64 and 66).

FIG. 6 shows an implementation of a magnet carrier 172 according to FIG. 3, for a multiple magnet linear actuator. The implementation of FIG. 6, there are n (in this example 6) pairs of transverse ribs 42A and 42B, 43A and 43B, 44A and 44B, 45A and 45B, 46A and 46B, and 47A and 47B which accommodate n−1 (in this example 5) pairs of magnetic structures 26-1A and 26-1B, 26-2A and 26-2B, 26-3A and 26-3B, 26-4A and 26-4B, and 26-5A and 26-5B.

Numerous uses of and departures from the specific apparatus and techniques disclosed herein may be made without departing from the inventive concepts. Consequently, the invention is to be construed as embracing each and every novel feature and novel combination of features disclosed herein and limited only by the spirit and scope of the appended claims.

What is claimed is:

1. A magnet carrier for a moving magnet motor, comprising:
a single longitudinal beam extending in the direction of intended motion of magnet carrier; and
two pairs of transverse ribs, extending from opposite sides of the longitudinal beam, wherein the longitudinal beam and the two pairs of transverse ribs are arranged to engage a pair of substantially planar magnet structures.

2. The magnet carrier of claim 1, wherein the moving magnet motor is a linear actuator.

3. The magnet carrier of claim 1, comprising n>2 pairs of transverse ribs, wherein the longitudinal beam and the n pairs for transverse ribs are arranged to engage n−1 pairs of magnet structures.

4. The magnet carrier of claim 1, wherein the magnet carrier is configured to engage the magnet structures on three sides of the magnets structures and to not engage a fourth side of the magnet structure.

5. The magnet carrier of claim 1, wherein the magnet carrier is a unitary structure.

6. The magnet carrier of claim 1, wherein the magnet carrier is a multi-piece structure and wherein a piece comprising the single longitudinal beam comprises a ferrous material.

7. The magnet carrier of claim 1, wherein the transverse ribs are perpendicular to the longitudinal beam.

8. An armature for a moving magnet, comprising:
a magnet carrier comprising
a single longitudinal beam extending in the direction of intended motion of magnet carrier; and
transverse ribs, extending from the longitudinal beam, wherein the longitudinal beam and the transverse ribs are arranged to engage a substantially planar magnet on three sides of a quadrilaterally shaped magnet.

9. The armature of claim 8, wherein pairs of transverse ribs extend from the longitudinal beam in opposite directions.

10. The armature of claim 8, wherein the armature is configured so that reactive force exerted on the magnet carrier is exerted in line with the single longitudinal beam.

11. The armature of claim 8, wherein the magnet carrier is a unitary structure.

12. The armature of claim 8, wherein the magnet carrier is a multi-piece structure and wherein a piece comprising the single longitudinal beam comprises a ferrous material.

13. The armature of claim 8, wherein the magnet carrier comprises n>2 pairs of transverse ribs, wherein the longitudinal beam and the n pairs for transverse ribs are arranged to engage n−1 pairs of magnet structures.

14. The armature of claim 8, wherein the transverse ribs are perpendicular to the longitudinal beam.

15. A linear actuator, comprising:
an armature for a moving magnet, comprising:
a magnet carrier comprising
a single longitudinal beam extending in the direction of intended motion of magnet carrier; and
transverse ribs, extending from the longitudinal beam, wherein the longitudinal beam and the transverse ribs are arranged to engage a substantially planar magnet structure;
wherein the armature is arranged so that reactive forces are applied to the armature in line with the single longitudinal beam.
